(19) United States
(12) Patent Application Publication
(10) Pub. No.: US 2024/0047721 A1
(43) Pub. Date: Feb. 8, 2024

(54) FUEL CELL SYSTEM AND METHOD OF CONTROLLING SHUTDOWN THEREOF

(71) Applicant: HYUNDAI MOBIS CO., LTD., Seoul (KR)

(72) Inventor: Se Hoon SONG, Yongin-si (KR)

(73) Assignee: HYUNDAI MOBIS CO., LTD., Seoul (KR)

(21) Appl. No.: 18/229,436

(22) Filed: Aug. 2, 2023

(30) Foreign Application Priority Data
Aug. 3, 2022 (KR) 10-2022-0096591

(51) Int. Cl. H01M 8/04955; H01M 8/04701; H01M 8/0432; H01M 8/04007; H01M 8/04119

(52) U.S. Cl. CPC H01M 8/04955; H01M 8/04738; H01M 8/0432; H01M 8/04037; H01M 8/04126

(57) ABSTRACT

A fuel cell system of this disclosure includes a fuel cell stack; a water supply unit to selectively supply cooling water or heated water to a cooler of the fuel cell stack, and including a heater for heating the cooling water; an air cutoff valve to supply air to an anode of the fuel cell stack and drain a residue from the anode; an anode pressure regulator to drain the residue from the air cutoff valve and control a pressure of the anode; sensors to measure an operating temperature of the fuel cell stack, an outside air temperature, and an atmospheric pressure; and a controller to calculate a target pressure for the anode, control the air cut-off valve, control the anode pressure regulator, and stop an operation of the heater when a stack voltage of the fuel cell stack is lower than a predetermined reference voltage.

### CROSS-REFERENCE TO RELATED APPLICATION

This application claims priority to and the benefit of Korean Patent Application No. 10-2022-0096591, filed on Aug. 3, 2022, the disclosure of which is incorporated herein by reference in its entirety.

### TECHNICAL FIELD

The present disclosure relates to a fuel cell system and a method of controlling shutdown thereof.

### BACKGROUND

Fuel cell systems are a kind of power generation system for directly converting chemical energy of fuel into electrical energy in a fuel cell (stack) electrochemically rather than converting the chemical energy into heat by combustion.

A fuel cell system includes a fuel cell stack for generating electrical energy through electrochemical reaction of reaction gases (hydrogen that is a fuel gas and oxygen that is an oxidant gas), a hydrogen supply device for supplying hydrogen, which is the fuel gas, to the fuel cell stack, an air supply device for supplying air containing oxygen to the fuel cell stack, a heat and water management system for controlling an operating temperature of the fuel cell stack and performing a water management function, and a controller for controlling the overall operation of the fuel cell system.

In shutdown control of turning off the fuel cell system, it is possible to prevent a lifetime of the fuel cell from being reduced by hydrogen peroxide or radicals only when a voltage of the fuel cell stack is decreased as much as possible by removing hydrogen or oxygen.

To this end, at the shutdown, it is necessary to prevent oxygen in the air from flowing into an anode by blocking an anode from the outside (e.g., blocking the air supplied to the fuel cell stack), then connecting a resistor such as a cathode oxygen depletion (COD) heater to react oxygen of the anode with hydrogen to be a nitrogen atmosphere, decreasing the voltage of the fuel cell stack, and maintaining the constant airtightness of the anode even in a standby state after shutdown.

However, when the oxygen of the anode is exhausted by the COD heater, the anode may become a negative pressure state and a time to increase a pressure of the anode to a normal pressure may be increased when the fuel cell system restarts.

In addition, it is possible to prevent the inflow of the oxygen in the air supplied from the air supply device to the fuel cell stack using an air cutoff valve (ACV) for shutdown control, but the inflow of the oxygen is made by a pressure difference between air and the anode when the airtightness of the ACV is poor, thereby making it difficult to perform the shutdown control.

In particular, the anode becomes a state of being vulnerable to the inflow of outside oxygen due to both a decrease in the pressure of the anode caused by a decrease in temperature of the fuel cell stack and a decrease in the pressure caused by condensation of water in a vapor state after shutdown of the fuel cell.

Therefore, it is necessary to control the anode so that the pressure of the anode becomes a pressure similar to an atmospheric pressure at shutdown of the fuel cell to minimize the inflow of outside oxygen even when the airtightness of the ACV is somewhat degraded.

### SUMMARY

The present disclosure is directed to providing a fuel cell system and a method of controlling shutdown thereof, which may control an anode so that a pressure of an anode becomes a pressure similar to an atmospheric pressure at the shutdown of the fuel cell system, thereby minimizing the inflow of outside oxygen even when the airtightness of an air cutoff valve (ACV) is somewhat degraded.

A method of controlling shutdown of a fuel cell system according to one embodiment of the present disclosure includes measuring an operating temperature of a fuel cell stack having an anode and a cathode, an outside air temperature, and an atmospheric pressure, calculating a target pressure for the anode of the fuel cell stack based on the measured operating temperature, the outside air temperature, and the atmospheric pressure, supplying air to the fuel cell stack, comparing a pressure of the anode with the target pressure, stopping the supply of the air to the fuel cell stack by closing an air cutoff valve when the pressure of the anode is the same as the target pressure, exhausting oxygen remaining in the anode by operating a heater, and stopping the operating of the heater when a stack voltage of the fuel cell stack is lower than a predetermined reference voltage by comparing the stack voltage with the reference voltage.

The method may further include comparing the pressure of the anode with the target pressure until the pressure of the anode becomes the same as the target pressure by increasing or decreasing an opening angle of an anode pressure regulator when the pressure of the anode is not the same as the target pressure.

In the method, the target pressure is obtained by dividing the atmospheric pressure by a pressure obtained by multiplying all of a first pressure which is a pressure reduction amount due to an exhaustion of oxygen supplied to the anode, a second pressure which is a pressure reduction amount due to a temperature decrease of the anode, and a third pressure which is a pressure reduction amount due to a condensation of water vapor at the anode.

In the method, the first pressure is obtained by Equation 1 of Pᵣₐₜᵢₒ₁=(100% −ratio of oxygen in air)=0.7905, the second pressure is obtained by Equation 2 of Pᵣₐₜᵢₒ₂=(T2+273.15)/(T1+273.15), and the third pressure is obtained by Equation 3 of

$${P}_{ratio 3} = \frac{exp ( ( 18.678 - \frac{{T}_{2}}{234.84} ) ( \frac{{T}_{2}}{257.14 + {T}_{2}} ) )}{exp ( ( 18.678 - \frac{{T}_{1}}{234.84} ) ( \frac{{T}_{1}}{257.14 + {T}_{1}} ) )} ,$$

in the Equations, T1 denotes the operating temperature of the fuel cell stack at the shutdown, T2 denotes the outside air temperature after the shut down, and a unit of the temperature is ° C.

In the method, the supplying of the air may include supplying the air by adjusting the air cutoff valve.

In the method, the operating temperature may be a measured temperature of a cooling water drained after circulating the fuel cell stack, the outside air temperature may be a temperature measured at an outside of the fuel cell stack, and the atmospheric pressure may be a pressure measured at the outside of the fuel cell stack.

In the method, the exhausting of the oxygen remaining in the anode may include exhausting the oxygen remaining in the anode by heating a cooling water that is supplied for cooling the anode and the cathode using the heater.

A fuel cell system according to one embodiment of the present disclosure includes a fuel cell stack including a cathode, an anode, and a cooler for cooling the cathode and the anode, a water supply unit configured to selectively supply a cooling water and heated water to the cooler and recover the cooling water and the heated water from the cooler and including a heater configured to heat the cooling water to supply the heated cooling water to the cooler when the fuel cell stack is shut down, an air cutoff valve configured to supply an air to the anode and drain a residue drained from the anode, an anode pressure regulator configured to drain the residue drained from the air cutoff valve to the outside and control a pressure of the anode, at least one sensor configured to measure an operating temperature of the fuel cell stack, an outside air temperature, and an atmospheric pressure, and a controller configured to calculate a target pressure for the anode of the fuel cell stack based on the operating temperature, the outside air temperature, and the atmospheric pressure measured by the at least one sensor, control the air cut-off valve to adjust a flow amount of the air supplied to the anode, control the anode pressure regulator so that the pressure of the anode becomes the same as the target pressure, and stop an operation of the heater when a stack voltage of the fuel cell stack is lower than a predetermined reference voltage.

In the fuel cell system, the controller may compare the pressure of the anode with the target pressure until the pressure of the anode becomes the same as the target pressure by increasing or decreasing an opening angle of the anode pressure regulator when the pressure of the anode is not the same as the target pressure.

In the fuel cell system, the target pressure may obtained by dividing the atmospheric pressure by a pressure obtained by multiplying all of a first pressure which is a pressure reduction amount due to an exhaustion of oxygen supplied to the anode, a second pressure which is a pressure reduction amount due to a temperature decrease of the anode, and a third pressure which is a pressure reduction amount due to a condensation of water vapor at the anode.

In the fuel cell system, the first pressure is obtained by Equation 1 of Pᵣₐₜₒ₁=(100%−ratio of oxygen in air)=0.7905, the second pressure is obtained by Equation 2 of Pᵣₐₜᵢₒ₂=(T2+273.15)/(T1+273.15), and the third pressure is obtained by Equation 3 of

$${P}_{ratio 3} = \frac{exp ( ( 18.678 - \frac{{T}_{2}}{234.84} ) ( \frac{{T}_{2}}{257.14 + {T}_{2}} ) )}{exp ( ( 18.678 - \frac{{T}_{1}}{234.84} ) ( \frac{{T}_{1}}{257.14 + {T}_{1}} ) )} ,$$

in the Equations, T1 denotes the operating temperature of the fuel cell stack at the shutdown, T2 denotes the outside air temperature after the shut down, and a unit of the temperature is ° C.

In the fuel cell system, the operating temperature may be a measured temperature of a cooling water drained after circulating the fuel cell stack, the outside air temperature may be a temperature measured at an outside of the fuel cell stack, and the atmospheric pressure may be a pressure measured at the outside of the fuel cell stack.

In the fuel cell system, the controller may exhaust the oxygen remaining in the anode by supplying the heated water obtained by controlling the heater to the anode.

In the fuel cell system, the controller may control the air cutoff valve to supply air to the fuel cell stack.

The fuel cell system may further include a condensed water storage and drain unit configured to store and drain the condensed water drained from the cathode, wherein the condensed water storage and drain unit may include: a storage trap configured to store the condensed water; and a drain valve configured to drain the condensed water when a level of the condensed water stored in the storage trap is greater than or equal to a predetermined level.

The fuel cell system may further include an air compressor configured to supply the air to the fuel cell stack, and a humidifier configured to humidify the air supplied from the air compressor to supply the humidified air to the fuel cell stack.

The fuel cell system may further include a fuel supply device configured to supply hydrogen to the cathode of the fuel cell stack, wherein the fuel supply device may include a flow control valve configured to control a supply amount of the hydrogen; a fuel supply valve configured to adjust a pressure of the hydrogen supplied from the flow control valve; and a fuel ejector configured to apply a pressure to the hydrogen supplied from the fuel supply valve and supply the hydrogen to the cathode of the fuel cell stack.

In the fuel cell system, the water supply unit may further include a radiator configured to remove heat from a water recovered from the cooler; a cooling water pump configured to condense a water supplied from the radiator and drain a condensed water; and a bypass valve configured to selectively supply a cooling water supplied from the cooling water pump to the cooler and the heater. Also the heater may heat the cooling water supplied from the bypass valve when the fuel cell stack is shutdown.

In the fuel cell system, the at least one sensor may include a first temperature sensor disposed on the water supply unit to measure a temperature of a cooling water recovered from the cooler; and an atmospheric pressure sensor connected to the controller to measure the atmospheric pressure. Also the temperature of the cooling water measured by the first temperature sensor may be the operating temperature.

In the fuel cell system, the at least one sensor may further include a second temperature sensor installed on an outer wall of the radiator to measure the outside air temperature.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a fuel cell system according to an embodiment of the present disclosure; and

FIG. 2 is a flowchart illustrating a method of turning off the fuel cell system according to the embodiment of the present disclosure.

### DETAILED DESCRIPTION OF EXEMPLARY EMBODIMENTS

The present embodiments may be modified in other forms or several embodiments may be combined, and the scope of the present disclosure is not limited to each of the embodiments to be described below.

Even when a matter described in a specific embodiment is not described in another embodiment, the matter may be understood as a description related to another embodiment unless there is a description contrary to or contradictory to the matter in another embodiment.

For example, when a feature of component A is described in a specific embodiment and a feature of component B is described in another embodiment, it should be understood that an embodiment in which components A and B are combined belongs to the scope of the present disclosure as long as there is no contrary or contradictory description even when the embodiment in which components A and B are combined is not explicitly described.

Terms such as first and second are used to describe various components. These terms are only for the purpose of distinguishing one component from another, and the nature, sequence, order, or the like of the corresponding component is not limited by these terms.

The terms used in the application are only used to describe specific embodiments and are not intended to limit the present disclosure. The singular expression includes the plural expression unless the context clearly dictates otherwise. In the application, it should be understood that terms such as “comprise” or “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

In addition, throughout the specification, when a certain component is described as being “connected” to another, this means that two or more components are directly connected and may mean that two or more components are indirectly connected through another component, physically connected, or electrically connected, or are referred to as different names depending on positions or functions thereof but are integrated.

Hereinafter, embodiments of a fuel cell system according to the present disclosure will be described in detail with reference to the accompanying drawings, and in describing the present disclosure with reference to the accompanying drawings, the same or corresponding components are denoted by the same reference numerals, and overlapping descriptions thereof will be omitted.

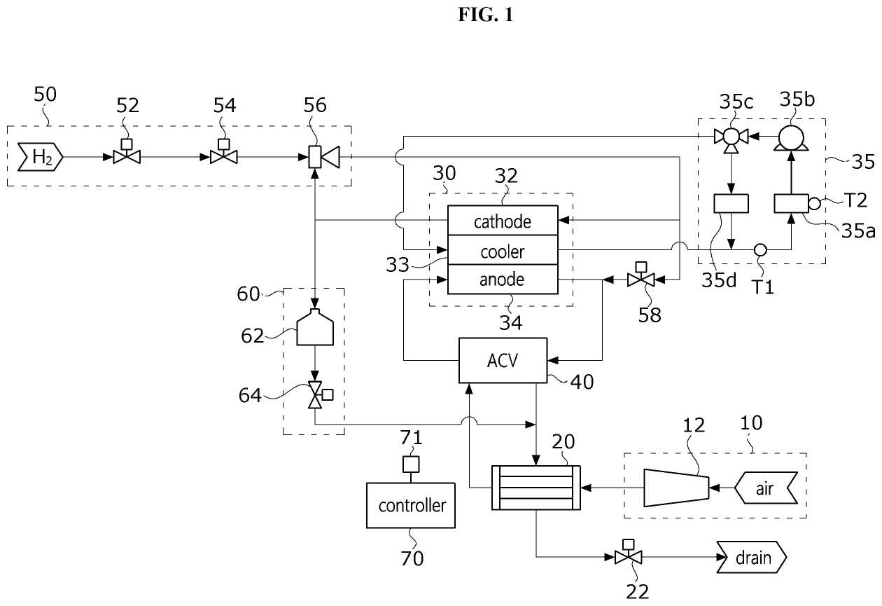

Hereinafter, a fuel cell system according to an embodiment of the present disclosure will be described with reference to FIG. 1.

FIG. 1 is a block diagram illustrating a fuel cell system according to the embodiment of the present disclosure.

Referring to FIG. 1, the fuel cell system according to the embodiment of the present disclosure may include an air supply unit 10, a humidifier 20, a fuel cell stack 30, a water supply unit 35, an air cutoff valve (ACV) 40, a hydrogen supply device a condensed water storage and drain unit 60, and a controller 70.

The air supply unit 10 may supply air (oxygen), which is an oxidizing agent required for the electrochemical reaction of the fuel cell stack 30. The air supply unit 10 may include an air compressor (ACP) 12 for supplying outside air and supply dust-filtered air to the humidifier 20 through an air cleaner.

The air compressor 12 drives a pump motor at high revolutions per minute (RPM) to oversupply air when receiving a low-temperature turn-off instruction of the fuel cell stack 30 from the controller 70. Therefore, hot air is supplied to the humidifier 20.

The controller 70 of the fuel cell system according to an exemplary embodiment of the present disclosure may be a processor (e.g., computer, microprocessor, CPU, ASIC, circuitry, logic circuits, etc.). The controller 70 may be implemented by a non-transitory memory storing, e.g., a program(s), software instructions reproducing algorithms, etc., which, when executed, performs various functions described hereinafter, and a processor configured to execute the program(s), software instructions reproducing algorithms, etc. Herein, the memory and the processor may be implemented as separate semiconductor circuits. Alternatively, the memory and the processor may be implemented as a single integrated semiconductor circuit. The processor may embody one or more processor(s).

The humidifier 20 may be implemented as a membrane humidifier including a hollow fiber membrane. The humidifier 20 may adjust the humidity of the air supplied from the air compressor 12 of the air supply unit 10 and supply moisture-containing air to the fuel cell stack 30.

The fuel cell stack 30 may include an anode and a cathode of a membrane electrode assembly (MEA) in which oxygen (air) and hydrogen, which are fuels of the fuel cell stack 30, are supplied through a flow path of a separator. In the fuel cell stack 30, the moisture-containing air (oxygen) supplied from the humidifier 21 may be supplied to an anode of the fuel cell stack 30, and hydrogen (H₂) supplied from the hydrogen supply device 50 may be supplied to a cathode of the fuel cell stack 30. The fuel cell stack 30 may generate a current by the reaction of a fuel cell when hydrogen and oxygen are supplied.

The water supply unit 35 may include a radiator 35a, a cooling water pump 35b, a bypass valve 35c, and a heater 35d.

The radiator 35a may remove heat from water recovered from a cooler 33 of the fuel cell stack 30.

The cooling water pump 35b may condense water supplied from the radiator 35a to drain a low-temperature cooling water.

The bypass valve 35c may selectively supply the cooling water supplied from the cooling water pump 35b to the cooler 33 or the heater 35d. For example, the bypass valve 35c may supply the cooling water supplied from the cooling water pump 35b to the heater 35d under the control of the controller 70 when the fuel cell stack starts in a sub-zero environment. The bypass valve 35c may supply the cooling water supplied from the cooling water pump 35b to the cooler 33 of the fuel cell stack 30 under the control of the controller 70.

The heater 35d heats the cooling water supplied from the bypass valve 35c and then circulates the heated water through the radiator 35a, the cooling water pump 35b, and the bypass valve 35c. When the heated water reaches an appropriate temperature, the controller 70 may supply the heated water to the cooler 33 of the fuel cell stack 30 through the bypass valve 35c. The heater 35d may be implemented as, for example, a cathode oxygen depletion (COD) heater.

The water supply unit 35 may further include a first temperature sensor T1 and a second temperature sensor T2.

The first temperature sensor T1 may measure a temperature of the cooling water recovered to the cooler 33. The first temperature sensor T1 is for measuring an operating temperature of the fuel cell stack 30 and is preferably installed on a pipe of the water supply unit 35 closest to the cooler 33.

The second temperature sensor T2 is for measuring an outside air temperature and may be installed on an outer wall of the radiator 35a.

The ACV 40 may control the supply of oxygen to maintain the humidity of oxygen (air), which is important in the reaction of the fuel cell stack 30. The ACV 40 may block the air (oxygen) supplied from the humidifier 21 to the anode of the fuel cell stack 30 under the control of the controller 70. The ACV 40 may also cut off the remaining moisture contained in the air supplied to the anode of the fuel cell stack 30 or drain the remaining moisture to the humidifier 21 under the control of the controller 70 when the remaining moisture is drained. The ACV 40 may be implemented as, for example, a solenoid valve.

The hydrogen supply device 50 may supply hydrogen (H₂), which is a fuel, to the fuel cell stack 30. The hydrogen supply device 50 may include a flow control valve (FCV) 52, a fuel supply valve (FSV) 54, and a fuel ejector (FEJ) 56.

The FCV 52 may control a supply amount of hydrogen. The FSV 54 may adjust a pressure of the hydrogen supplied to the fuel cell stack 30. The FEJ 56 may apply a pressure to the hydrogen and supply the hydrogen to the cathode of the fuel cell stack 30. The hydrogen supply device 50 may adjust the amount and pressure of the hydrogen supplied as fuel through the FCV 52 and the FSV 54 and then supply the hydrogen to the cathode of the fuel cell stack 30 through the FEJ 56.

The fuel cell system according to the embodiment of the present disclosure may further include an anode pressure regulator 22 and a fuel-line purge valve (FPV) 58. In one embodiment, the anode pressure regulator 22 may be a type of a valve.

The anode pressure regulator 22 may drain the residue drained from the ACV 40 to the outside. The anode pressure regulator 22 may control a pressure of an anode 34 by adjusting a degree of opening of the valve under the control of the controller 70. For example, the anode pressure regulator 22 may increase the pressure of the anode 34 by decreasing an opening angle of the valve and decrease the pressure of the anode 34 by increasing the opening angle of the valve.

The purge valve 58 may forcibly drain hydrogen supplied to the cathode of the fuel cell stack 30.

The condensed water storage and drain unit 60 may include a condensed water trap (Fuel-line Water Trap, FWT) 62 for storing the condensed water generated at the cathode of the fuel cell stack 30 as much as a predetermined level and a condensed drain valve (Fuel-line Drain Valve, FDV) 64 for draining the condensed water. The FDV 64 is controlled by the controller 70 to supply the condensed water drained from the FWT 62 to the humidifier 21 to be recycled.

The controller 70 may control each component of the fuel cell system, and the controller will be described below.

The controller 70 may receive an operating temperature of the fuel cell stack, an outside air temperature, and an atmospheric pressure.

The operating temperature of the fuel cell stack 30 may be measured by the first temperature sensor T1 installed on the pipe of the water supply unit 35 closest to the cooler 33 of the fuel cell stack 30.

The outside air temperature may be measured by the second temperature sensor T2 installed on the outer wall of the radiator 35a of the water supply unit 35.

The atmospheric pressure may be measured through a pressure sensor 71 installed on the controller 70. Since the pressure sensor 71 is formed of a physically vulnerable thin film, the pressure sensor 71 may be protected by being disposed on a board of the controller 70. However, the embodiment of the present disclosure is not limited thereto, and the pressure sensor 71 may be installed together with a separate protection unit separated from the controller 70 or may be installed to be exposed to the atmosphere. When the pressure sensor 71 is installed on the controller 70 formed in a watertight type, a vent plug (not illustrated) provided on the controller 70 may be disposed to be connected to the pressure sensor 71 to measure the atmospheric pressure.

The controller 70 may calculate target pressure for the anode 34 suitable for the operation of the fuel cell stack 30 based on the operating temperature, the outside air temperature, and the atmospheric pressure, which are measured by the first and second temperature sensors T1 and T2 and the pressure sensor 71.

A target pressure may be obtained by dividing the atmospheric pressure by a pressure obtained by multiplying all of a first pressure (Pᵣₐₜᵢₒ₁) which is a pressure reduction amount due to an exhaustion of the oxygen supplied to the anode 34 of the fuel cell stack 30, a second pressure (Pᵣₐₜᵢₒ₂) which is a pressure reduction amount due to a decrease in temperature of the anode, and a third pressure (Pᵣₐₜᵢₒ₃) which is a pressure reduction amount due to a condensation of water vapor at the anode.

The first pressure (Pᵣₐₜᵢₒ₁) may be obtained through Equation 1 below.

Pᵣₐₜᵢₒ₁=(100%−ratio of oxygen in the air)=0.7905 [Equation 1]

The second pressure (Pᵣₐₜᵢₒ₂) may be obtained through Equation 2 below.

Pᵣₐₜᵢₒ₂=(T₂+273.15)/(T₁+273.15) [Equation 2]

When the temperature of the anode 34 decreases, a saturated vapor pressure is decreased by an influence of the decrease in the temperature, and the water vapor in the anode is phase-transformed into a condensed water. Assuming that relative humidity is maintained at 100% because sufficient water is present inside the anode 34 of the fuel cell stack 30, a total decrease in the pressure may be inferred from a saturated vapor pressure ratio before and after the decrease in the temperature. There are several estimation equations for the saturated vapor pressure, and the Buck-equation widely used among them is as follows. A temperature unit is ° C., and a pressure unit is kPa.

$$P = 0.61121 exp ( ( 18.678 - \frac{T}{234.84} ) ( \frac{T}{257.14 + T} ) ) ,$$

Therefore, the third pressure (Pᵣₐₜᵢₒ₃), which is the decrease in the pressure caused by the condensation of water vapor at the anode, may be obtained through Equation 3 below.

$${P}_{ratio 3} = \frac{exp ( ( 18.678 - \frac{{T}_{2}}{234.84} ) ( \frac{{T}_{2}}{257.14 + {T}_{2}} ) )}{exp ( ( 18.678 - \frac{{T}_{1}}{234.84} ) ( \frac{{T}_{1}}{257.14 + {T}_{1}} ) )} \qquad [ Equation 3 ]$$

Therefore, a final pressure decrease ratio may be obtained through Equation 4 below.

Pᵣₐₜᵢₒ=Pᵣₐₜᵢₒ₁×Pᵣₐₜᵢₒ₂×Pᵣₐₜᵢₒ₃ [Equation 4]

In Equations, T1 denotes the operating temperature of the fuel cell stack at the shutdown, T2 denotes the outside air temperature after the shutdown, and the unit of the temperature is ° C.

Then, the controller 70 may control a current pressure of the anode 34 to become the same as the target pressure of the anode 34 after supplying air to the fuel cell stack 30 by controlling the air compressor 12 of the air supply unit 10.

To this end, the controller 70 may compare the pressure of the anode with the target pressure to check whether the pressure of the anode and the target pressure are the same. As a comparison result, when the pressure of the anode 34 and the target pressure are the same, the controller 70 may block air by controlling the ACV 40, thereby stopping the supply of the air to the fuel cell stack 30.

However, when the pressure of the anode 34 and the target pressure are not the same, the controller 70 may control the pressure of the anode 34 to become the same as the target pressure by increasing or decreasing the opening angle of the anode pressure regulator 22. For example, when the pressure of the anode 34 is lower than the target pressure, the pressure of the anode 34 may be adjusted to become the same as the target pressure by decreasing the opening angle of the anode pressure regulator 22 to increase the pressure of the anode 34. Conversely, when the pressure of the anode 34 is higher than the target pressure, the pressure of the anode 34 may be adjusted to become the same as the target pressure by increasing the opening angle of the anode pressure regulator 22 to decrease the pressure of the anode 34.

Then, the controller 70 may control the heater 35d of the water supply unit to heat the cooling water supplied through the cooling water pump 35b and the bypass valve 35c. Therefore, since the heated cooling water circulates through the radiator 35a, the cooling water pump 35b, and the bypass valve 35c and then is supplied to the cooler 33, the oxygen remaining in the anode 34 is exhausted by the heated water, and only nitrogen remains.

The controller 70 may compare a stack voltage of the fuel cell stack with a predetermined reference voltage and stop an operation of the heater 35d when the stack voltage is lower than the reference voltage.

According to the above-described configuration, since the state in which the stack voltage is lower than the reference voltage is maintained even when the fuel cell system including the fuel cell stack is shut down, it is possible to prevent the anode from becoming the negative pressure after the shutdown, thereby preventing physical stress caused by a difference in the pressure applied to the MEA of the fuel cell stack, and prevent degradation in the durability of the fuel cell caused by the inflow of outside oxygen, thereby increasing the lifetime of the fuel cell system.

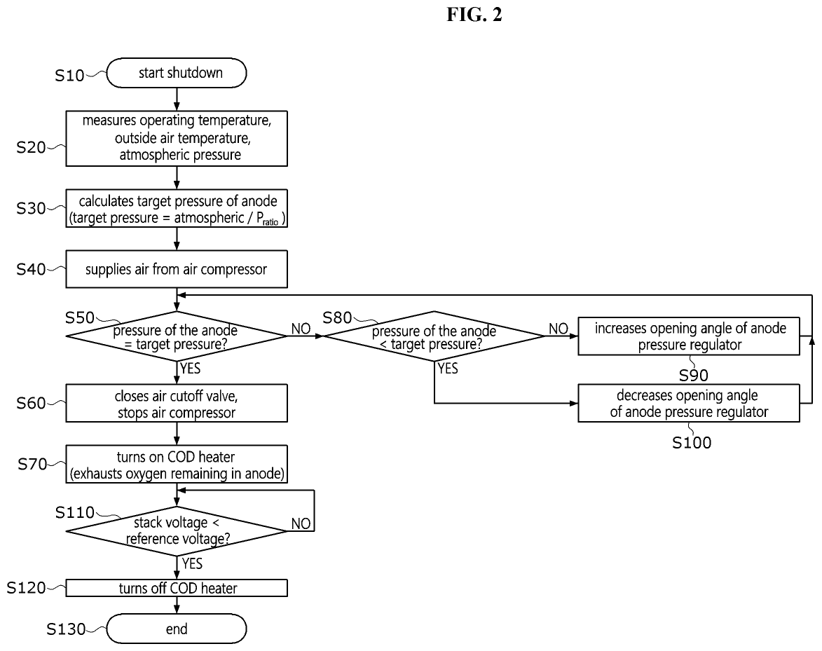

Then, a low-temperature turn-off method of the fuel cell system according to the embodiment of the present disclosure will be described with reference to FIG. 2.

FIG. 2 is a flowchart illustrating a method of shutting down (turning off) the fuel cell system according to the embodiment of the present disclosure. Referring to FIG. 2, the shutdown (turn-off) of the fuel cell system according to the embodiment of the present disclosure starts (S10).

First, an operating temperature of the fuel cell stack 30, an outside air temperature, and an atmospheric pressure are measured (S20). The operating temperature of the fuel cell stack 30 may be measured using the first temperature sensor T1 installed on the pipe of the water supply unit 35. The outside air temperature may be measured using the second temperature sensor T2 installed on the outer wall of the radiator 35a of the water supply unit 35. The atmospheric pressure may be measured through a pressure sensor 71 installed on the controller 70. The operating temperature of the fuel cell stack 30, outside air temperature, and atmospheric pressure, which are measured as described above, may be supplied to the controller 70.

Then, the controller 70 calculates the target pressure for the anode 34 of the fuel cell stack 30 based on the measured operating temperature, outside air temperature, and atmospheric pressure (S30).

Since the calculation of the target pressure has already been described in the detailed description made with reference to FIG. 1, the calculation of the target pressure will be omitted to avoid an overlapping description.

The air compressor 12 of the air supply unit 10 supplies the minimum flow air to the fuel cell stack 30 under the control of the controller 70 (S40).

The controller 70 compares the pressure of the anode 34 of the fuel cell stack 30 with the target pressure of the anode 34 to check whether the pressure of the anode 34 of the fuel cell stack 30 and the target pressure of the anode 34 are the same (S50).

As a comparison result, when the pressure of the anode 34 and the target pressure of the anode 34 are not the same, the process proceeds to operation S80, and when the pressure of the anode 34 and the target pressure of the anode 34 are the same, the process proceeds to operation S60.

In operation S80, by comparing the pressure of the anode 34 with the target pressure of the anode 34, when the pressure of the anode 34 is higher than the target pressure, the process proceeds to operation S90, and when the pressure of the anode 34 is lower than the target pressure, the process proceeds to operation S100.

In operation S80, when the pressure of the anode 34 is higher than the target pressure, the pressure of the anode 34 is decreased by increasing the opening angle of the anode pressure regulator 22, and then the process returns to operation S50.

In operation S80, when the pressure of the anode 34 is lower than the target pressure, the pressure of the anode 34 is increased by decreasing the opening angle of the anode pressure regulator 22, and then the process returns to operation S50.

As described above, when the pressure of the anode 34 and the target pressure of the anode 34 are not the same, the pressure of the anode 34 may be adjusted to be the same as the target pressure by repeating operations S80, S90, and S100.

When the pressure of the anode 34 becomes the same as the target pressure, the ACV 40 is closed under the control of the controller 70, and the air compressor 12 of the air supply unit 10 is stopped to cut off the supply of the oxygen supplied to the fuel cell stack 30 from the air supply unit 10 (S60).

After stopping the supply of the air (oxygen) to the fuel cell stack 30, the controller 70 controls the bypass valve 35c to supply cooling water to the heater (COD heater) 35d, and the heater 35d heats the supplied cooling water and then circulates the cooling water through the radiator 35a, the cooling water pump 35b, and the bypass valve 35c to supply the cooling water to the cooler 33 of the fuel cell stack. Oxygen remaining in the anode 34 is exhausted by the heated water supplied to the cooler 33, and only nitrogen remains in the anode 34 (S70).

Then, the controller 70 compares the stack voltage of the fuel cell stack 30 with the predetermined reference voltage (S110). As a result of comparing the stack voltage of the fuel cell stack 30 with the reference voltage, when the stack voltage is higher than the reference voltage, operation S110 is repeated until the stack voltage becomes lower than the reference voltage.

When the stack voltage of the fuel cell stack 30 is lower than the reference voltage, the controller 70 stops the operation of the heater 34d (S120) and ends the shutdown (turn-off) of the fuel cell system (S130).

According to a fuel cell system and a low-temperature turn-off method thereof according to an embodiment of the present disclosure, it is possible to prevent an anode from becoming a negative pressure after shutdown of a fuel cell, thereby preventing physical stress caused by a difference in a pressure applied to an MEA of a fuel cell stack, and to prevent degradation in the durability of the fuel cell caused by the inflow of outside oxygen, thereby increasing a lifetime of the fuel cell system.

Although the aspects of the present disclosure have been described in more detail with reference to the accompanying drawings, the present disclosure is not limited thereto and may be embodied in many different forms without departing from the technical concept of the present disclosure. Therefore, the aspects disclosed in the present disclosure are provided for illustrative purposes only and are not intended to limit the technical concept of the present disclosure. The scope of the technical concept of the present disclosure is not limited thereto. Therefore, it should be understood that the above-described aspects are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A method of controlling shutdown of a fuel cell system, comprising:
measuring an operating temperature of a fuel cell stack having an anode and a cathode, an outside air temperature, and an atmospheric pressure;
calculating a target pressure for the anode of the fuel cell stack based on the measured operating temperature, the outside air temperature, and the atmospheric pressure;
supplying air to the fuel cell stack;
comparing a pressure of the anode with the target pressure;
stopping the supplying of the air to the fuel cell stack by closing an air cutoff valve when the pressure of the anode is the same as the target pressure;
exhausting oxygen remaining in the anode by operating a heater; and
stopping the operating of the heater when a stack voltage of the fuel cell stack is lower than a predetermined reference voltage by comparing the stack voltage with the reference voltage.

2. The method of claim 1, further comprising comparing the pressure of the anode with the target pressure until the pressure of the anode becomes the same as the target pressure by increasing or decreasing an opening angle of an anode pressure regulator when the pressure of the anode is not the same as the target pressure.

3. The method of claim 1, wherein the target pressure is obtained by dividing the atmospheric pressure by a pressure obtained by multiplying all of a first pressure which is a pressure reduction amount due to an exhaustion of oxygen supplied to the anode, a second pressure which is a pressure reduction amount due to a temperature decrease of the anode, and a third pressure which is a pressure reduction amount due to a condensation of water vapor at the anode.

4. The method of claim 3, wherein the first pressure is obtained by Equation 1 below,
the second pressure is obtained by Equation 2 below, and
the third pressure is obtained by Equation 3 below,
$${P}_{r a t i o 1} = ( 100 \% - ratio of oxygen in air ) = 0.7905 , \qquad [ Equation 1 ]$$
$${P}_{r a t i o 2} = ( T 2 + 273.15 ) / ( T 1 + 273.15 ) , and \qquad [ Equation 2 ]$$
$${P}_{ratio 3} = \frac{exp ( ( 18.678 - \frac{{T}_{2}}{234.84} ) ( \frac{{T}_{2}}{257.14 + {T}_{2}} ) )}{exp ( ( 18.678 - \frac{{T}_{1}}{234.84} ) ( \frac{{T}_{1}}{257.14 + {T}_{1}} ) )} , \qquad [ Equation 3 ]$$
wherein, in the Equations, T1 denotes the operating temperature of the fuel cell stack at the shutdown, T2 denotes the outside air temperature after the shutdown, and a unit of the temperature is ° C.

5. The method of claim 4, wherein the operating temperature is a measured temperature of a cooling water drained after circulating the fuel cell stack,
the outside air temperature is a temperature measured at an outside of the fuel cell stack, and
the atmospheric pressure is a pressure measured at the outside of the fuel cell stack.

6. The method of claim 1, wherein the supplying of the air includes supplying the air by adjusting the air cutoff valve.

7. The method of claim 1, wherein the exhausting of the oxygen remaining in the anode includes exhausting the oxygen remaining in the anode by heating a cooling water that is supplied for cooling the anode and the cathode using the heater.

8. A fuel cell system comprising:
a fuel cell stack including a cathode, an anode, and a cooler for cooling the cathode and the anode;
a water supply device configured to selectively supply a cooling water or a heated water to the cooler and recover the cooling water and the heated water from the cooler, and including a heater configured to heat the cooling water to supply the heated cooling water to the cooler when the fuel cell stack is shutdown;
an air cutoff valve configured to supply an air to the anode and drain a residue drained from the anode;
an anode pressure regulator configured to drain the residue drained from the air cutoff valve to an outside and control a pressure of the anode;
at least one sensor configured to measure an operating temperature of the fuel cell stack, an outside air temperature, and an atmospheric pressure; and
a controller configured to:
calculate a target pressure for the anode of the fuel cell stack based on the operating temperature, the outside air temperature, and the atmospheric pressure measured by the at least one sensor,
control the air cut-off valve to adjust a flow amount of the air supplied to the anode,
control the anode pressure regulator so that the pressure of the anode becomes the same as the target pressure, and
stop an operation of the heater when a stack voltage of the fuel cell stack is lower than a predetermined reference voltage.

9. The fuel cell system of claim 8, wherein the controller compares the pressure of the anode with the target pressure until the pressure of the anode becomes the same as the target pressure by increasing or decreasing an opening angle of the anode pressure regulator when the pressure of the anode is not the same as the target pressure.

10. The fuel cell system of claim 8, wherein the target pressure is obtained by dividing the atmospheric pressure by a pressure obtained by multiplying all of a first pressure which is a pressure reduction amount due to an exhaustion of oxygen supplied to the anode, a second pressure which is a pressure reduction amount due to a temperature decrease of the anode, and a third pressure which is a pressure reduction amount due to a condensation of water vapor at the anode.

11. The fuel cell system of claim 10, wherein the first pressure is obtained by Equation 1 below,
the second pressure is obtained by Equation 2 below, and
the third pressure is obtained by Equation 3 below,
$${P}_{r a t i o 1} = ( 100 \% - ratio of oxygen in air ) = 0.7905 , \qquad [ Equation 1 ]$$
$${P}_{r a t i o 2} = ( T 2 + 273.15 ) / ( T 1 + 273.15 ) , and \qquad [ Equation 2 ]$$
$${P}_{ratio 3} = \frac{exp ( ( 18.678 - \frac{{T}_{2}}{234.84} ) ( \frac{{T}_{2}}{257.14 + {T}_{2}} ) )}{exp ( ( 18.678 - \frac{{T}_{1}}{234.84} ) ( \frac{{T}_{1}}{257.14 + {T}_{1}} ) )} , \qquad [ Equation 3 ]$$
wherein, in Equations, T1 denotes the operating temperature of the fuel cell stack at the shutdown, T2 denotes the outside air temperature after the shutdown, and a unit of the temperature is ° C.

12. The fuel cell system of claim 8, wherein the operating temperature is a measured temperature of a cooling water drained after circulating the fuel cell stack,
the outside air temperature is a temperature measured at an outside of the fuel cell stack, and
the atmospheric pressure is a pressure measured at the outside of the fuel cell stack.

13. The fuel cell system of claim 8, wherein the controller exhausts the oxygen remaining in the anode by supplying the heated water obtained by controlling the heater to the anode.

14. The fuel cell system of claim 8, wherein the controller controls the air cutoff valve to supply air to the fuel cell stack.

15. The fuel cell system of claim 8, further comprising a condensed water storage and drain unit configured to store and drain the condensed water drained from the cathode,
wherein the condensed water storage and drain unit includes:
a storage trap configured to store the condensed water; and
a drain valve configured to drain the condensed water when a level of the condensed water stored in the storage trap is greater than or equal to a predetermined level.

16. The fuel cell system of claim 8, further comprising an air compressor configured to supply the air to the fuel cell stack; and
a humidifier configured to humidify the air supplied from the air compressor to supply the humidified air to the fuel cell stack.

17. The fuel cell system of claim 8, further comprising a fuel supply device configured to supply hydrogen to the cathode of the fuel cell stack,
wherein the fuel supply device includes:
a flow control valve configured to control a supply amount of the hydrogen;
a fuel supply valve configured to adjust a pressure of the hydrogen supplied from the flow control valve; and
a fuel ejector configured to apply a pressure to the hydrogen supplied from the fuel supply valve and supply the hydrogen to the cathode of the fuel cell stack.

18. The fuel cell system of claim 8, wherein the water supply unit further includes:
a radiator configured to remove heat from a water recovered from the cooler;
a cooling water pump configured to condense a water supplied from the radiator and drain a condensed water; and
a bypass valve configured to selectively supply a cooling water supplied from the cooling water pump to the cooler and the heater, and
the heater heats the cooling water supplied from the bypass valve when the fuel cell stack is shutdown.

19. The fuel cell system of claim 8, wherein the at least one sensor includes:
a first temperature sensor disposed on the water supply unit to measure a temperature of a cooling water recovered from the cooler; and
an atmospheric pressure sensor connected to the controller to measure the atmospheric pressure, and
wherein the temperature of the cooling water measured by the first temperature sensor is the operating temperature.

20. The fuel cell system of claim 18, wherein the at least one sensor further includes a second temperature sensor installed on an outer wall of the radiator to measure the outside air temperature.
